(19) United States
(12) Patent Application Publication
(10) Pub. No.: US 2001/0005071 A1
(43) Pub. Date: Jun. 28, 2001

(54) Frame for skates

(76) Inventors: Roberto Gorza, Feltre (IT); Luca Bertolo, Treville Di Castelfranco Veneto (IT); Andrea Brait, Lido (IT)

Correspondence Address: MODIANO & ASSOCIATI, Via Meravigli, 16, 20123 MILANO, IT

(21) Appl. No.: 09/752,761

(22) Filed: Jan. 3, 2001

Related U.S. Application Data
(63) Continuation of application No. PCT/EP00/04277, filed on May 11, 2000.

(30) Foreign Application Priority Data
May 13, 1999 (IT) TV99A000056

(51) Int. Cl. B62C 1/00; B62D 61/00

(52) U.S. Cl. 280/67

(57) ABSTRACT

A frame for skates comprising two bases for supporting a shoe and two blades for the axial support of wheels. At least two contact surfaces for mutual adhesive bonding are formed between the bases and the blades and are arranged on different planes.

### CROSS-REFERENCE TO RELATED APPLICATIONS

This application is a continuation of application number PCT/EP00/04277 filed on May 11, 2000.

### BACKGROUND OF THE INVENTION

The present invention relates to a frame for skates.

Conventional skates generally comprise a shoe associated with a wheel supporting frame made of plastics or of light metals and, in some specific cases, by using composite materials such as carbon fibers, glass fibers or fibers known by the trademark Kevlar.

These frames, which are formed monolithically, provide for a different use of materials mainly in order to make the skate adapted to particular levels of technical and structural performance as well as according to the overall selling price of said skate.

The process for manufacturing a frame made entirely of metal is in fact more expensive than the process for manufacturing a frame made of plastics, owing to the large number of machining steps that the frame must undergo in order to obtain the finished product having the intended characteristics and owing to the different purchasing cost of the raw materials.

Accordingly, a frame made of metal is generally used in skates requiring high performance, such as speed skates, while the use of plastics allows to obtain skates which require lower performances, such as leisure skates.

It is also known to produce composite frames made of components fixed to one another by means of screws, rivets, pins or interlocking couplings which ensure the necessary technical and structural characteristics required by sports practice.

NL-8701675 discloses a roller skate with adjustable and interchangeable base, the wheel supporting frame thereof being manufactured by means of components which are associated one another by adhesive bonding.

The above skate suffers several drawbacks: the figures show that the coupled surfaces of the various components cannot ensure adequate mechanical strength, since said surfaces are not large enough and are therefore subjected to very intense stress for example during thrusting and braking, when the forces, by acting laterally, become considerable and may therefore cause the separation of the lateral wings of the frame from the remaining components.

It is in fact noted that adhesive substances in general are characterized by excellent resistance to shearing stress and therefore to stresses which act parallel to the layer of adhesive and at right angles to the ground.

Said shearing stress can be caused by unevenness in the ground, by the weight of the user, by jumps and by impacts against the ground.

Adhesive substances are instead much less resistant to tensile stresses and therefore to stresses at right angles to the layer of adhesive, caused for example by lateral thrusting for propulsion, by lateral braking and during slalom.

### SUMMARY OF THE INVENTION

The aim of the present invention is to solve the above-noted problems by eliminating the drawbacks of the prior art by providing a skate frame whose technical and structural characteristics are equal to, or better than, those of conventional frames but without using rivets, fixing screws or mechanical connections among the various frame components.

An important object is to provide a supporting frame having light overall weight.

Another important object is to provide a wheel supporting frame requiring a small number of production steps.

Another important object is to provide a supporting frame for skate wheels which is structurally solid and adapted to withstand all the stresses that can be applied to it during skating.

Another object is to provide a frame which associates with the preceding characteristics that of being reliable and safe in use and has low manufacturing costs.

This aim and other objects which will become better apparent hereinafter are achieved by a frame for skates, comprising at least one base member and two blades adapted to support wheels, characterized in that at least two contact surfaces for mutual adhesive bonding are formed between said at least one base member and each of said blades and are arranged on different planes.

### BRIEF DESCRIPTION OF THE DRAWINGS

Further characteristics and advantages of the invention will become better apparent from the detailed description of particular but not exclusive embodiments thereof, illustrated only by way of non-limitative example in the accompanying drawings, wherein:

FIG. 1 is a side view of a skate;

FIGS. 2 and 3 are sectional views, taken along the line II-II and III-III of FIG. 1;

FIG. 4 is a side view of another embodiment of the frame according to the invention;

FIG. 5 is a detail view of the embodiment of FIG. 4;

FIG. 6 is a sectional view, taken along the line VI-VI of FIG. 4;

FIG. 7 is a side view of another embodiment;

FIG. 8 is a sectional view, taken along the line VIII-VIII of FIG. 7;

FIG. 9 is a side view of another embodiment of the skate;

FIG. 10 is a sectional view, taken along the line X-X of FIG. 9;

FIG. 11 is a side view of another embodiment of the skate;

FIG. 12 is a sectional view, taken along the line XII-XII of FIG. 11;

FIG. 13 is a side view of another embodiment of the skate;

FIG. 14 is a sectional view, taken along the line XIV-XIV of FIG. 13;

FIG. 15 is a partial side view of a skate provided with a frame according to still a further aspect of the invention;

FIG. 16 is a sectional view according to line XVI-XVI of FIG. 15;

FIG. 17 is a perspective view of the base of the frame of FIGS. 15 and 16.

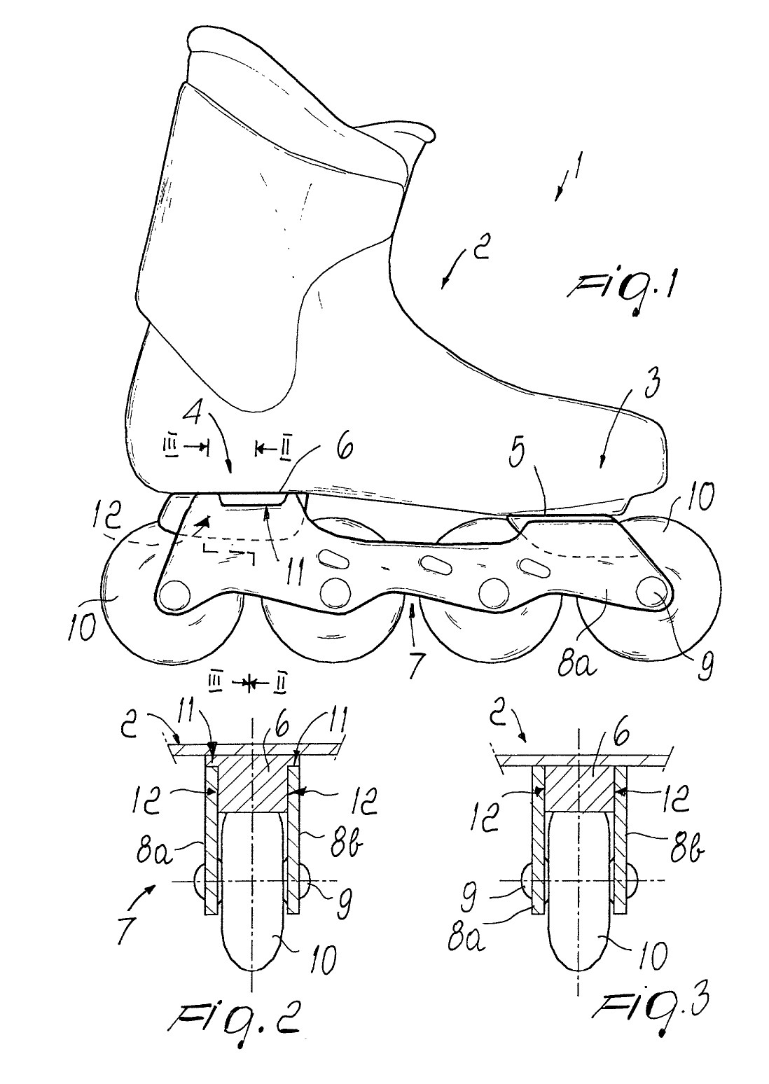

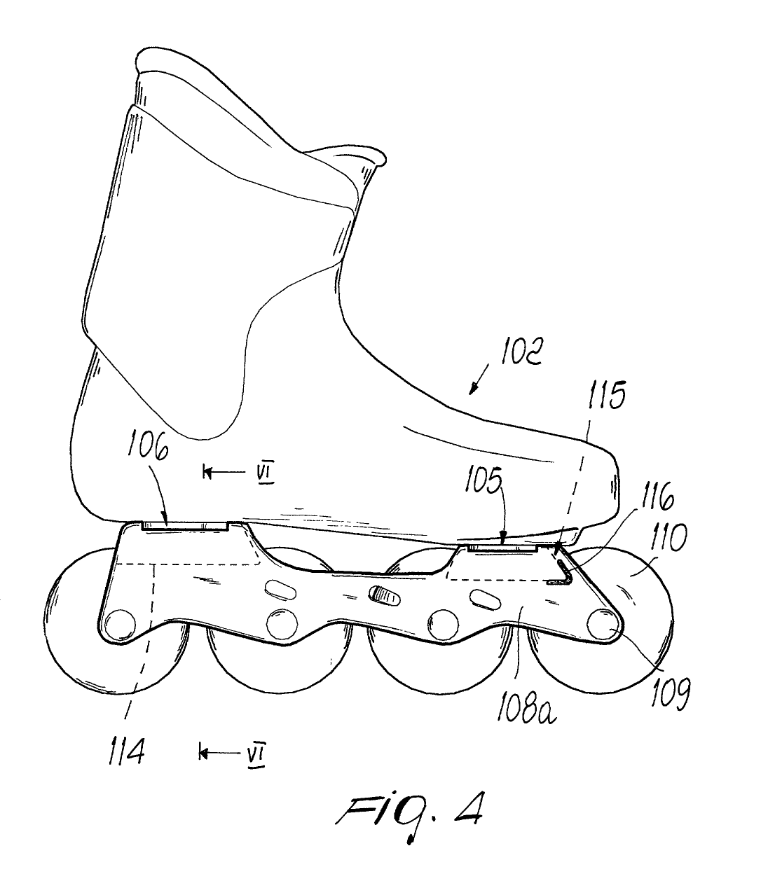

### DESCRIPTION OF THE PREFERRED EMBODIMENTS

With reference to the above figures, the reference numeral 1 designates a skate which comprises a soft or rigid shoe 2, which is connected, at the toe region 3 and at the heel region 4, to a first base 5 and to a second base 6 of a frame which is generally designated by the reference numeral 7.

Said frame comprises two blades 8a and 8b between which pivots 9 are arranged transversely; an adapted wheel 10 is axially associated with each one of said pivots.

The first and second bases have such a shape as to support the shoe in an upward region and have a first surface 11 and a second surface 12 for contact with the pair of blades 8a and 8b which are arranged on different planes.

In the embodiment shown in FIG. 2, the first and second bases have a substantially T-shaped cross-section in which the stem is directed toward the ground.

The first surface 11 is arranged on a horizontal plane with respect to the ground, while the second surface 12 is arranged on a plane which is perpendicular to the ground; said two surfaces are therefore preferably arranged at right angles to each other.

An adapted adhesive substance is interposed between the first and second surfaces of the first and second bases and the corresponding surfaces of the blades 8a and 8b that are adjacent thereto; said substance is constituted, for example, by the two-part adhesive marketed by the 3M company as 9323 B/A or is constituted by a film adhesive marketed by the same company as AF163-2 or AF10.

The particular arrangement and configuration of the first and second surfaces of the first and second bases allow to ensure, together with the adhesive that is used, optimum connection of the components of the frame, allowing to achieve optimum resistance to shearing stresses, which act parallel to the layer of adhesive and at right angles to the ground, and to traction stresses, i.e.. stresses at right angles to the layer of the adhesive or parallel to the ground.

It has thus been observed that the invention has achieved the intended aim and objects, a frame having been provided which has optimum technical and structural characteristics and therefore optimum resistance to the various stresses that can be applied thereto during skating, said frame being obtainable without using rivets or screws for fixing, thus achieving a considerable cost saving owing to the reduction in the number of parts and in the corresponding production and assembly steps.

A considerable reduction in the overall weight of the frame is also achieved owing to the absence of rivets or screws and to the particular connection of various elements that compose it, at the same time utilizing in full the technical characteristics of the adhesive despite using bonding surfaces which may be reduced to a minimum.

The invention is susceptible to numerous modifications and variations, all of which are within the scope of the same inventive concept.

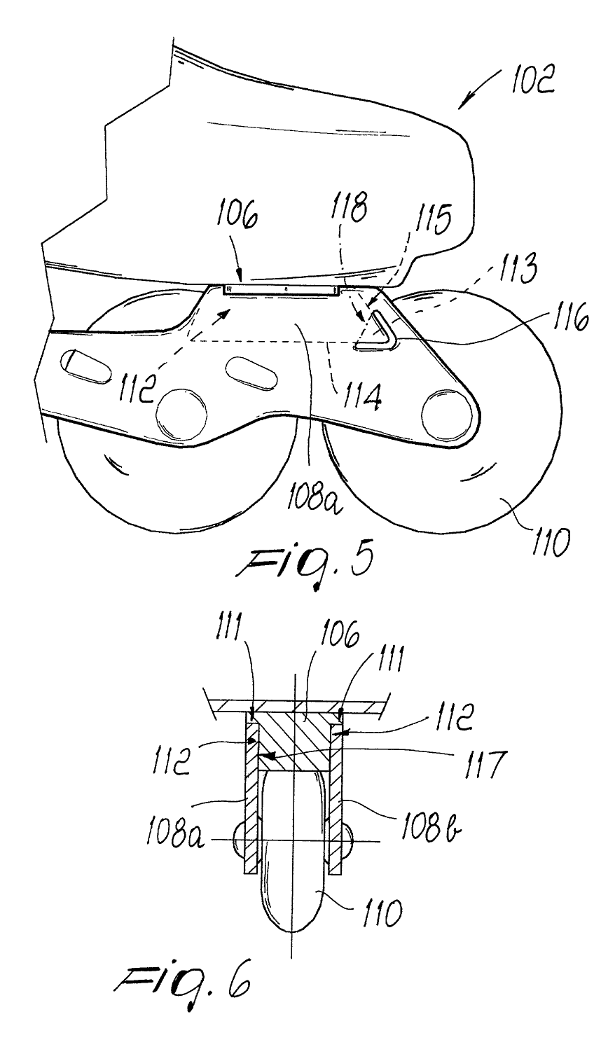

Thus, for example, in FIGS. 4, 5 and 6 the first base 105 and the second base 106 again have a substantially T-shaped transverse cross-section and the wings that are provided with the first surfaces 111 can be accommodated at complementarily shaped seats formed laterally with respect to the blades 108a and 108b, preferably at the upper perimetric edge.

Moreover, in this embodiment, the second surfaces 112 have, in plan view, a substantially trapezoidal shape in which the corner 113 that connects the longer parallel side 115 to the side 115 that is directed toward the front part of the shoe 102 lies at an adapted and complementarily shaped slot 116 formed in the adjacent internal and/or external lateral surface 117 of the blades 108a, 108b.

Said slot 116 can be of the recessed, through or protruding type, and its purpose is to shift the stress resistance front from the corner 113 to the line 118 that connects the corners of the slot 116, which is advantageously V-shaped.

This allows to increase the resistance area and therefore adequate resistance to stresses, including traction stresses at right angles to the layer of adhesive, is obtained even in the front region of, for example, the front wheel 110.

With this refinement, the front part of the blades 108a and 108b is in fact given more freedom to deform due to said stresses without discharging them onto the portion of the corner 113, with the risk of causing the separation of the blade from the base 106.

This embodiment allows to perform adhesive bonding, in the manufacture of skate frames, even for elements made of different materials such as plastics, aluminum, carbon fiber or fibers known by the trade-mark Kevlar, so long as they are chemically compatible with the bonding agent.

This leads to a further considerable saving of costs because of the reduction in production steps and in the number of parts used, in addition to ensuring a considerable weight reduction indeed because of the absence of rivets or mechanical connection systems.

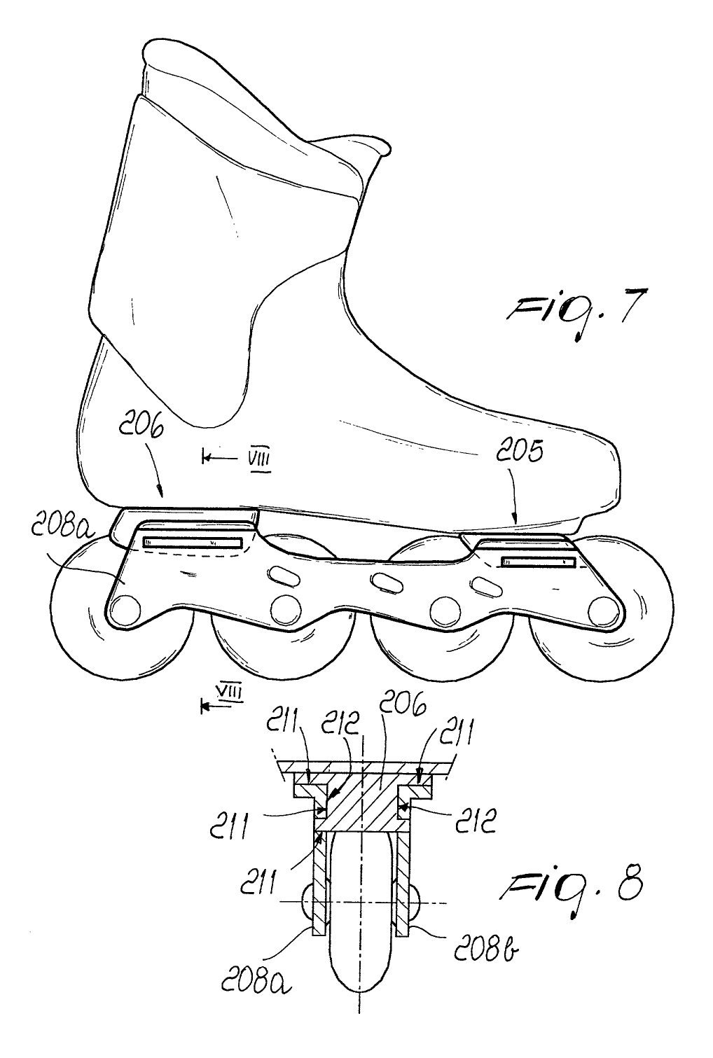

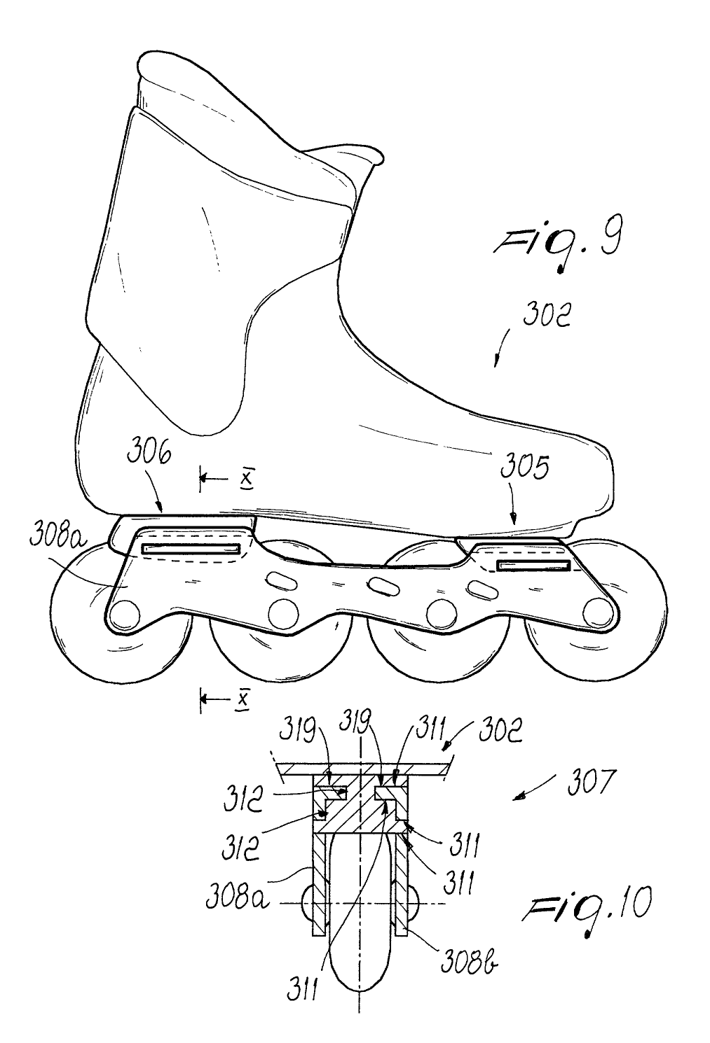

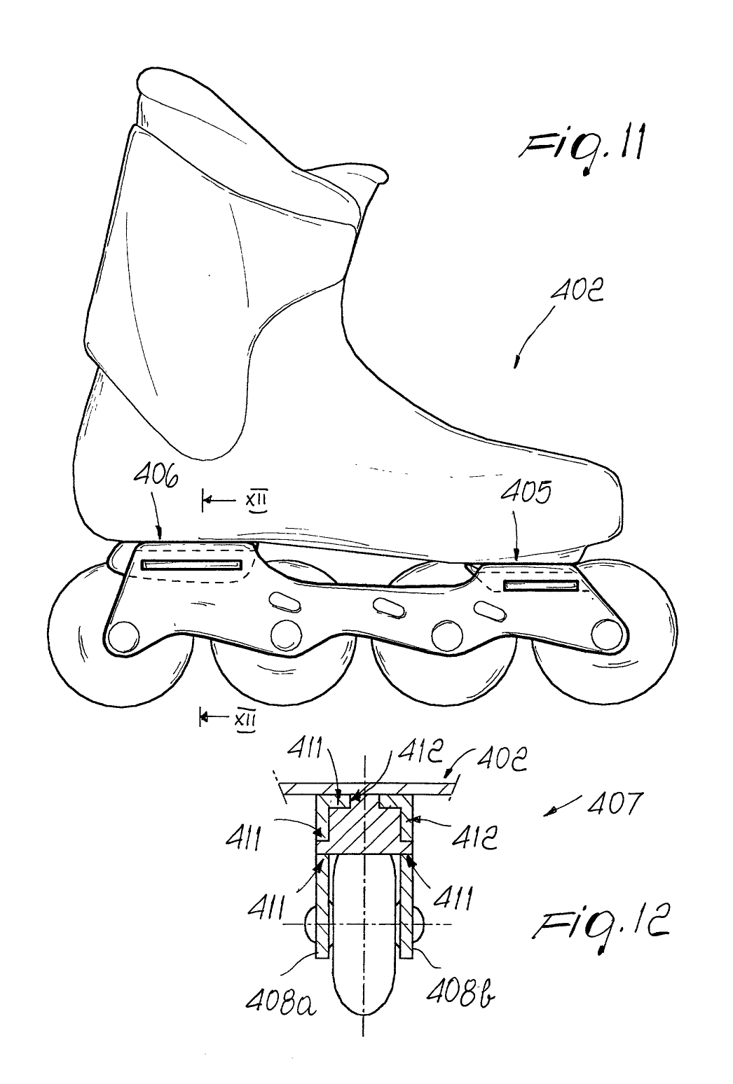

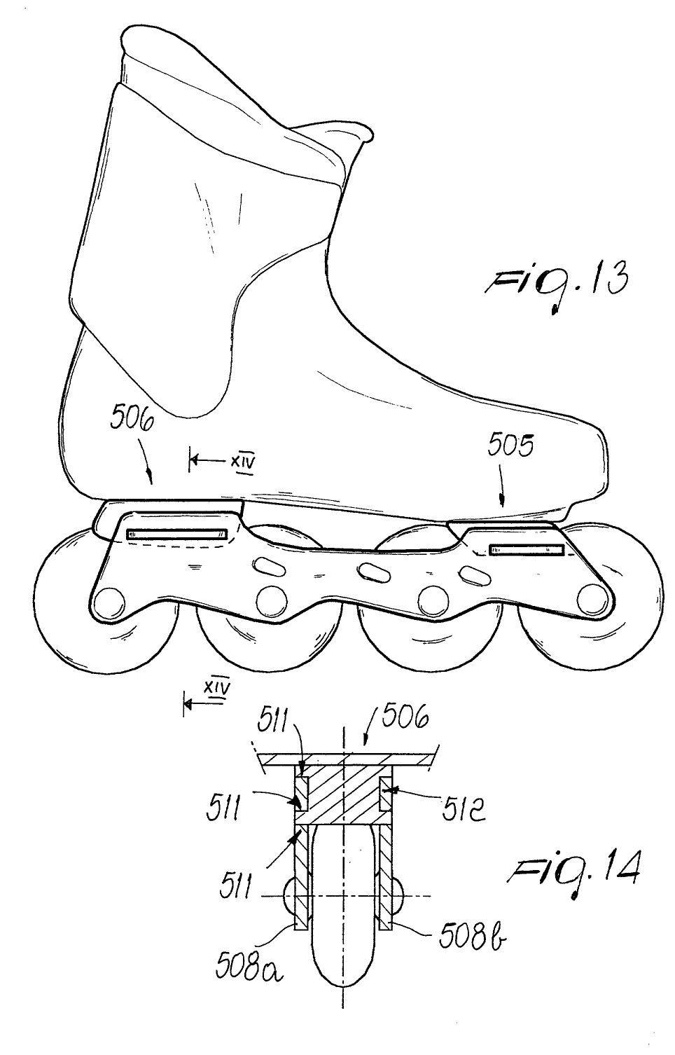

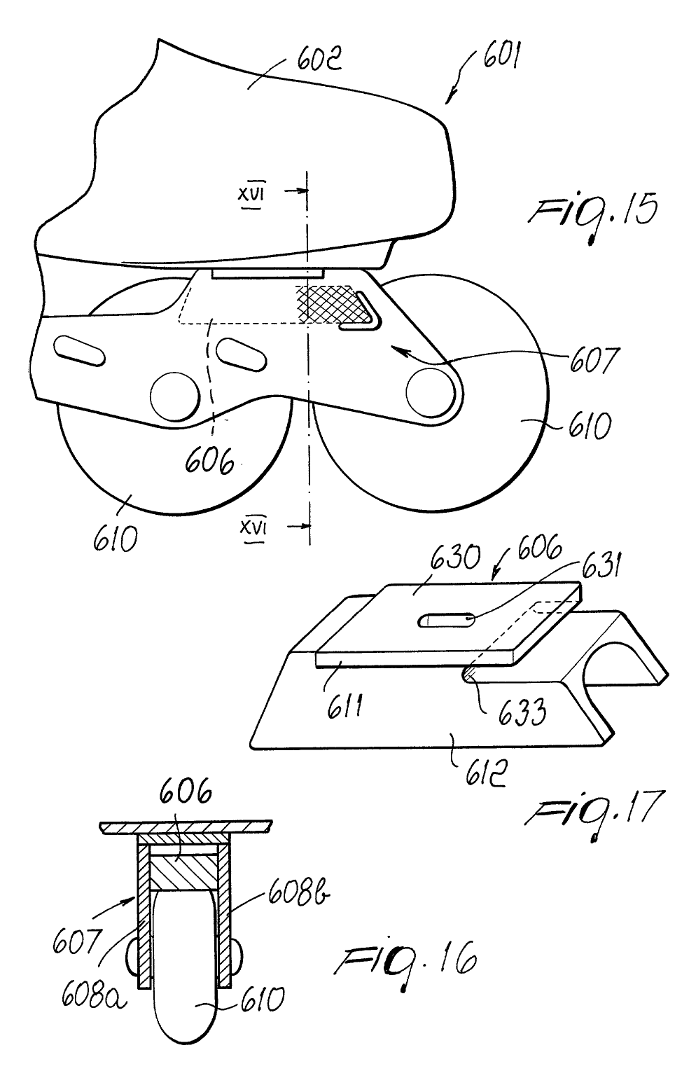

FIGS. 7 and 8 illustrate another embodiment in which the first base 205 and the second base 206 are substantially H-shaped so as to form, with respect to the blades 208a and 208b, three separate first surfaces 211 which are parallel to the ground for mutual adhesive bonding and single second surfaces 212 arranged on a plane which is perpendicular to the ground.

The bonding surfaces are thus increased although the difference in planes is maintained.

FIGS. 9 and 10 illustrate another embodiment in which the frame 307 has two blades 308a, 308b which have a substantially L-shaped transverse cross-section in which the shorter sides 319 are arranged adjacent to the overlying shoe 302 and face each other.

The first base 305 and the second base 306 are shaped complementarily to the adjacent end of the blades and this allows to again form a plurality of first mutual bonding surfaces 311 arranged on a plane which is parallel to the ground and also a plurality of second mutual bonding surfaces 312 arranged on plane which are perpendicular to the ground.

FIGS. 11 and 12 illustrate another embodiment for a frame 407 in which the blades 408a and 408b are substantially L-shaped, but in which the with shorter wings 419 instead abut against the lower surface of the shoe 402.

In this case also, the first base 405 and the second base 406 have an inverted T-shaped transverse cross-section in which the stem is shaped complementarily to the ends of the blades that are provided with the smaller wings.

A plurality of first mutual bonding surfaces 411, arranged on planes which are parallel to the ground, and a plurality of second mutual bonding surfaces 412, arranged on planes which are perpendicular to the ground, are is thus formed once again.

FIGS. 13 and 14 illustrate another embodiment in which the first base 505 and the second base 506 have a substantially H-shaped transverse cross-section, thus forming, with respect to the blades 508a, 508b, a plurality of first mutual bonding surfaces 511 arranged on planes which are parallel to the ground and a single second mutual bonding surface 512 which is arranged on a plane which is perpendicular to the ground.

FIGS. 15-17 illustrate a further embodiment of the invention wherein a frame 607 can be associated to a shoe 602 to provide a roller skate 601.

Frame 607 comprises two blades 608a, 608b, adapted to support a plurality of wheels 610, and a base member 606 provided between the two blades.

Base member 606 has two side surfaces 612 adapted to be glued to the blades 608a and 608b, and an upper wider portion 630 which defines further side surfaces 611 which overlap the blades 608a and 608b respectively.

Upper portion 630 has a slot 631 for connecting a shoe 602.

The base member 606 is provided with a front relief or undercut 633 which greatly enhances the stress resistance of the base member, particularly with respect of the lateral or transverse direction.

The materials used for the individual components or the particular type of bonding agent, as well as the shape of the first and second bases and of the blades, may of course be more pertinent according to specific requirements.

The disclosures in Italian Patent Application No. TV99A000056 from which this application claims priority are incorporated herein by reference.

1. A frame for skates, comprising at least one base member and two blades adapted to support wheels, characterized in that at least two contact surfaces for mutual adhesive bonding are formed between said at least one base member and each of said blades and are arranged on different planes.

2. The frame according to claim 1, characterized in that said base member has such a shape as to support a shoe in an upper region and has a first surface and a second surface for contact with said blades, said surfaces being arranged on different planes.

3. The frame according to claim 1, characterized in that said base member has a substantially T-shaped transverse cross-section in which the stem is directed toward the ground.

4. The frame according to claim 1, characterized in that said first surface is arranged on a horizontal plane with respect to the ground, while said second surface is arranged on a plane which is perpendicular to the ground.

5. The frame according to claims 1 and 3, characterized in that said first and second surfaces are arranged approximately at 90° to each other.

6. The frame according to claim 1, characterized in that said base member has a substantially T-shaped transverse cross-section, on the wings of which first surfaces are formed which can be accommodated at complementarily shaped seats formed laterally to said blades.

7. The frame according to claim 6, characterized in that said second surfaces have, in a side view, a substantially trapezoidal shape in which the corner that connects the longer parallel side to the side that is directed toward the front part of said shoe lies at an adapted and complementarily shaped slot formed in the adjacent internal and/or external lateral surface of said blades.

8. The frame according to claim 7, characterized in that said slot is V-shaped and is a recessed, through or protruding slot.

9. The frame according to one or more of the preceding claims, characterized in that said first and second bases are substantially H-shaped so as to form, with respect to said blades, three separate first surfaces which are parallel to the ground for mutual adhesive bonding and single second surfaces which are arranged on a plane which is perpendicular to the ground.

10. The frame according to one or more of the preceding claims, characterized in that said two blades have a substantially L-shaped transverse cross-section in which the shorter wings are arranged in a region which is adjacent to said overlying shoe and face each other.

11. The frame according to one or more of the preceding claims, characterized in that said base member is shaped complementarily to the adjacent end of said blades so as to form a plurality of first mutual bonding surfaces arranged on a plane which is parallel to the ground and a plurality of second mutual bonding surfaces arranged on planes which are perpendicular to the ground.

12. The frame according to one or more of the preceding claims, characterized in that said blades are substantially L-shaped and their shorter wings abut against the lower surface of said shoe, said base member having an inverted T-shaped transverse cross-section in which the stem is shaped complementarily to the ends of said blades that are provided with said shorter wings.

13. The frame according to one or more of the preceding claims, characterized in that said base member has a substantially H-shaped transverse cross-section so as to form, with respect to said blades, a plurality of first mutual bonding surfaces which are arranged on planes which are parallel to the ground and a single second mutual bonding surface which lies on a plane which is perpendicular to the ground.

14. The frame according to claim 1, characterized in that said base member has two side portions each forming a main surface for connecting a blade, an upper portion forming two side lower surfaces and having connection means for a shoe.

15. The frame of claim 14, characterized in that said base member has an undercut provided between said side portions and said upper portion.
